(19) United States
(12) Patent Application Publication
(10) Pub. No.: US 2004/0133473 A1
(43) Pub. Date: Jul. 8, 2004

(54) Method and apparatus for serving drinks

(76) Inventors: Iain W. Anderson, Staffordshire (GB); Wendy G. Box, Staffordshire (GB); Peter T. Foster, Staffordshire (GB); Rachel J. Galt, Staffordshire (GB); Stuart W. Molzahn, Derbyshire (GB); David E. Quain, Staffordshire (GB); Stephen P. Smith, Derbyshire (GB); Robert A. Wright, Derbyshire (GB)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/338,437

(22) Filed: Jan. 8, 2003

(51) Int. Cl. G06F 17/60

(52) U.S. Cl. 705/15; 705/16

(57) ABSTRACT

A method of serving a drink at a counter 6 of a drinks bar comprises providing a digital camera 2 connected to a printer 3 adjacent a nozzle 5 for delivering draught beverage into a glass 4. The camera takes a picture of the ambient surroundings and/or of a person in or adjacent to the bar, and then the printer prints the picture at 7 on the glass at the time or shortly before the drink is served in the glass.

### FIELD OF THE INVENTION

This invention concerns serving drinks and apparatus associated therewith, as well as the decoration of articles associated with the serving of drinks.

### BACKGROUND TO THE INVENTION

Serving drinks, for example at a bar, is generally a fairly mechanical process, and generally contributes little to the drinking experience, and can even be a negative part of the experience. It is therefore desirable to make the purchase of drinks at a bar a more interesting experience, both for the benefit of the customer and for the vendor.

### SUMMARY OF THE INVENTION

According to a first aspect of the invention there is provided a method of serving a drink to a person at a serving location, the method comprising: capturing an image at the serving location, providing an article, reproducing the image on the article, dispensing the drink, and presenting the drink and the article to the person.

Preferably the article is presented to the person with the drink. Preferably the article is vessel, and the article is presented to the person containing the drink. The vessel may be is a glass. Alternatively the article may comprise an article to be presented to the customer with the beverage, such as a mat, a serviette or a stirrer. Alternatively the drink may be presented in a vessel and the article applied to the vessel, for example in the form of a label.

Preferably the image is of a scene at the serving location. Where the serving location is a room, the image may be captured within the room. Preferably the method comprises selecting a person at the serving location, and the image is an image of the selected person, who may be the person to whom the drink is served.

The image is reproduced by printing. The image may be reproduced on the vessel, either by direct printing or by the application of an adhesive label, while the drink is being dispensed into the vessel.

The present invention further provides a method of selling a drink to a customer at a point of sale, the method comprising: capturing an image at the point of sale, providing an article, reproducing the image on the article, dispensing the drink, and presenting the drink and the article to the customer.

The present invention further provides apparatus for serving a drink to a person, the apparatus comprising a camera for capturing an image, a printer for reproducing the image, a support for supporting a vessel, and a dispensing nozzle for dispensing the drink into the vessel.

The apparatus may be arranged to reproduce the image on the vessel. For example the printer may be arranged to reproduce the image directly onto the vessel, or the printer may be arranged to print the image on an article which is adapted to be applied to the vessel. In this case the apparatus is preferably arranged to apply the article to the vessel.

The printer may be arranged to reproduce the image on an article intended to be presented to the person, such as an object to be presented to the person with the drink. The article can be a mat, a stirrer or a serviette.

The present invention further provides apparatus for serving a drink to a person, the apparatus comprising image capturing means for capturing an image, image reproducing means for reproducing the image, a support for supporting a vessel, and a dispensing nozzle for dispensing the drink into the vessel.

The present invention still further provides a drinks bar whereat a drink is to be served to a person, said bar being provided with a camera arranged to capture an image in the vicinity of the bar, and reproducing means to reproduce the image on an article intended to be presented to said person. The drinks bar may be further provided with a drink dispenser arranged to supply draught beverage, and the reproducing means disposed adjacent to the dispenser. Preferably the reproducing means is in an enclosure. More preferably the drinks bar is further provided with a drink dispenser arranged to supply draught beverage, and the dispenser is provided in said enclosure.

The present invention further provides a method of serving a drink to a person at a serving location, the method comprising: selecting an image, providing an article, reproducing the image on the article, dispensing the drink, and presenting the drink and the article to the person. The image may be selected from a database of images.

The present invention still further provides a method of serving a drink to a person at a serving location comprising capturing an image at the serving location, transmitting the image for display at a remote location, and presenting the drink to the person. The image may be transmitted to a display screen for display, in which case it may be displayed instantaneously on the screen. Alternatively the image may be transmitted to a remote receiving device, such as a mobile phone or a PC, and stored for viewing on request.

The present invention yet further provides a method of decorating a beverage mat comprising capturing an image at a location and reproducing the image on the mat. The image may be reproduced directly onto the mat or reproduced onto a label which is applied to the mat. Preferably the location is a bar area where beverage is served. More preferably the image is of at least one person in the bar area, such as a customer purchasing a drink.

The present invention still further provides apparatus for serving a drink to a person at a serving location, the method comprising: control means for selecting an image, image reproduction means for reproducing the image on the article, and dispensing means for dispensing the drink. Preferably the apparatus further comprises storage means having a database of images stored therein for selection by the control means. The apparatus may further comprise a camera and the control means be arranged to control the camera so as to select the image. Alternatively the apparatus may further comprise communication means for downloading the image from a remote source.

The present invention yet further provides apparatus for decorating a beverage mat comprising a camera arranged to capture an image of a location and image reproduction means arranged to reproduce the image on the beverage mat.

Preferred embodiments of the present invention will now be described by way of example only with reference to the accompanying drawings.

### BRIEF DESCRIPTION OF THE DRAWINGS

FIG. 1 is a schematic view of an apparatus according to a first embodiment of the invention;

FIG. 2 is a schematic view of an apparatus according to a second embodiment of the invention;

FIG. 3 shows a beverage mat with a label from the apparatus of FIG. 2 applied to it;

FIG. 4 is a schematic view of a drinks bar according to a third embodiment of the invention; and

FIG. 5 is a diagram of part of the apparatus partly shown in FIG. 4.

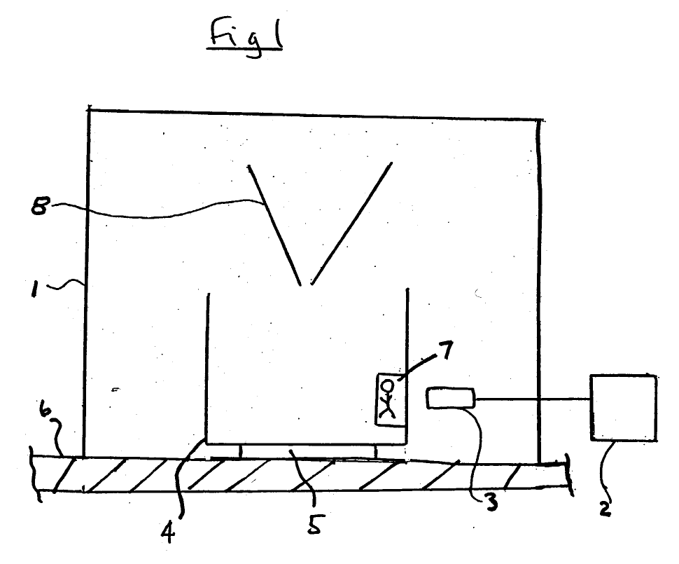

### DESCRIPTION OF THE PREFERRED EMBODIMENTS

A cabinet 1 encloses an inkjet printer 3 and a glass 4. The glass 4 sits on a support 5 on the counter 6 of a drinks bar. The printer 3 is associated with a camera 2 and is arranged to print images captured by the camera 2 directly onto the glass 4 while it is supported on the support 5. The camera 2 is a digital camera, and is arranged to take a picture of the ambient surroundings in the bar and adjacent to the bar counter. In this embodiment the camera 2 is set up to take a photograph of a person or persons in or adjacent to the bar and to print this picture 7 onto the glass 4 in which a drink is to be served at the bar 6. A delivery nozzle 8 supplies draught beverage to the vessel 4.

In a modification to the embodiment described above, the support 5 is rotatable and is rotated with the glass 4 on it while the beverage is being dispensed into it. The image 7 is also printed onto the glass as it is rotated, which has the advantage of reducing the amount of movement required of the head of the printer 3, and also of speeding up the whole serving process.

Referring to FIG. 2, in a second embodiment of the invention, a font 20 is provided on the counter 22 of a drinks bar. The font includes a support 24 on which a glass 26 can be stood, and a dispense nozzle 28 from which a draught beverage can be dispensed into the glass 26 while it is on the support. A camera 30 is mounted on the ceiling of the bar over the bar counter 22 and as arranged to take a photograph of a customer 32 who is being served at the bar counter. The font 20 includes a control unit 33 and printer 34 which is connected to the camera 30 and arranged to print out transparent adhesive labels carrying the image captured by the camera 30.

When the customer 32 wishes to purchase a drink he orders the drink, a glass 26 is placed on the support 24 and the font is activated by a switch 34. This causes the drink to be dispensed into the glass 26, and also causes the camera 30 to take a digital photographic image of the area in front of the bar where the customer is standing. This image is communicated to the printer 34 which prints out an adhesive label 36 bearing the image of the customer 32. The label is then adhered to the glass 26 which is presented to the customer containing the drink. The customer then pays for the drink to complete the purchase transaction.

In a modification to the second embodiment, the support 24 is arranged to rotate the glass 26, and the printer 34 is arranged to apply the adhesive label to the glass as it is rotated.

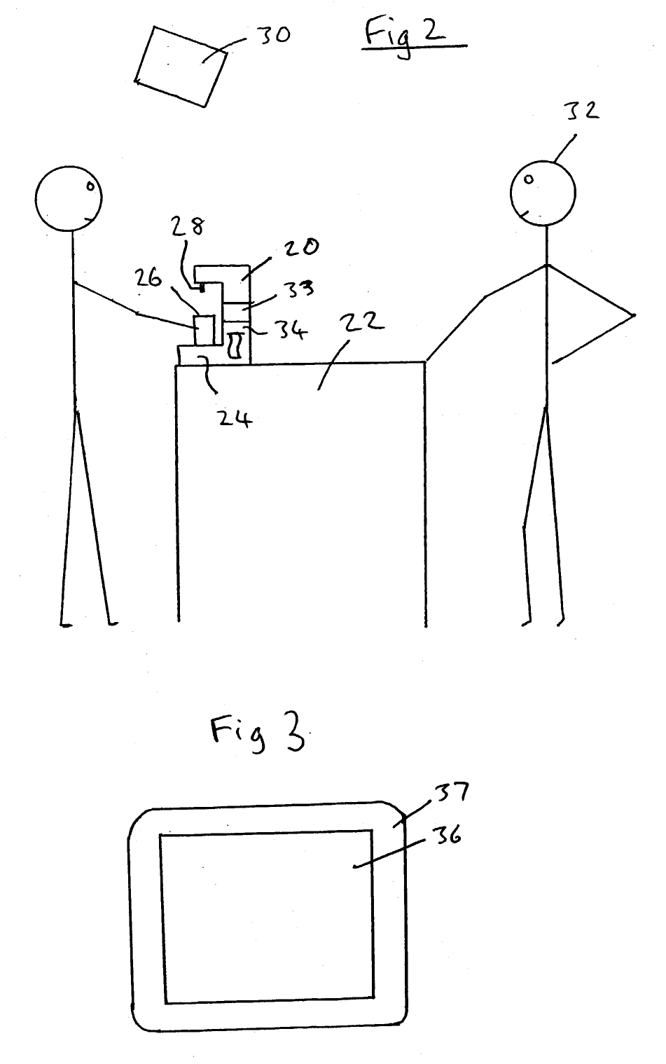

Referring to FIG. 3 in a further modification the adhesive label 36 is applied to a beverage mat, such as a beer mat 37, which is presented to the customer with the beverage.

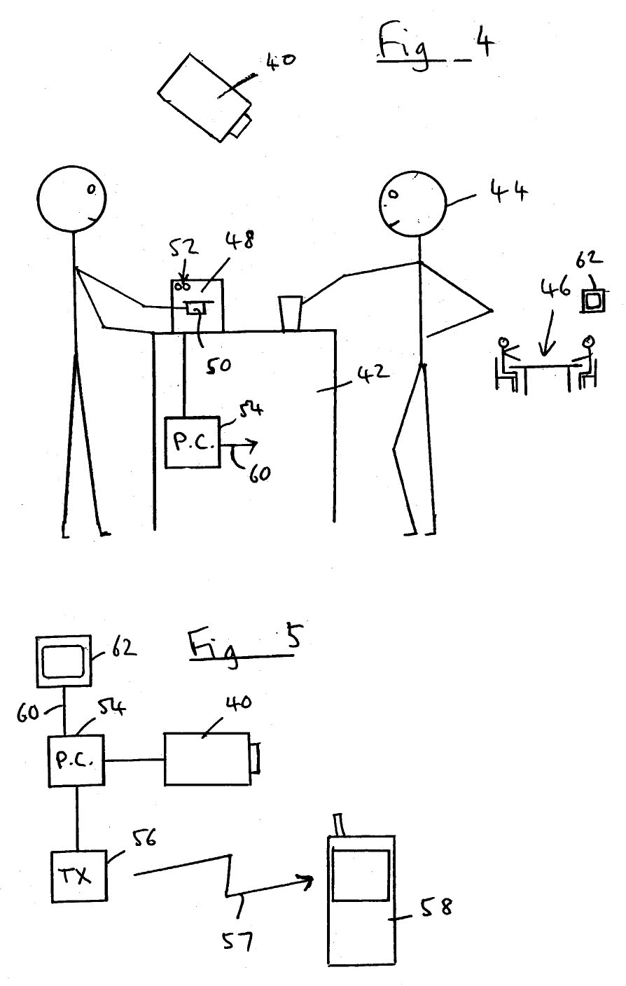

Referring to FIGS. 4 and 5, in a third embodiment of the invention a camera 40 is mounted in a bar over a bar counter 42. The camera is movable so that it can capture a digital photographic image of either a customer 44 standing at the bar, or of any of a number of tables 46 in the bar. The camera is connected to a printer 48 on the bar counter 42 which is arranged to print the captured image onto an article 50 suitable for serving up to the customer with the drink. In this embodiment the article is a beer mat. However it will be appreciated that other personalized items could be produced such as stirrers or drinking straws or serviettes.

The printer 48 is also connected to a database of images stored on a personal computer 54. The computer 54 is also connected to telecommunications interface 56 which can transmit digital signals via a telecommunications network 57 to a receiving unit such a mobile phone 58. The computer is also connected via a cable 60 to a screen 62 in the bar area so that it can display images from the camera 40 or computer database 54 on the screen 62. A user input 52 on the printer 48 allows a user, such as a bar tender, to request the printer to print out images from the camera 40 or from the computer database 54, or to transmit images from either of these to chosen destination, for example inputting a mobile telephone number. In a further modification to this system the link with the remote unit 58 may be two-way, for example comprising an internet connection, so that the image to be displayed can be downloaded from the remote unit.

When ordering a drink the customer firstly specifies the drink required and is asked whether he would like a picture to be printed onto an article from the printer 48, displayed on the screen 62, or transmitted digitally over the telecommunications network. The customer is then asked whether he would like a picture of himself or of one of the tables in the bar, or a picture from the computer database 54 or a remote source. His response is keyed into the printer 48 via a user interface 52 comprising a number of buttons 53. While the customer's drink is being prepared or dispensed, the computer 54 controls the selection of the image, either by controlling the camera to select the required view and capture the digital image, or by retrieving the image from the database 54, or over the telecommunications link from the remote unit 58. The image is then communicated to the selected destination, either the printer 48 where it is printed onto the beer mat 50, the screen 62 where it is displayed, or the mobile telephone 58 where it is received and stored for display on request by a user. The customer then pays for the drink to complete the purchase transaction.

The image database or the remote source may include images of famous people, places or events, or up-to-date representations of contemporaneous events such as sporting events.

It will be appreciated that that printer 48 of FIG. 4 may be incorporated in a beverage dispensing apparatus similar to that of FIG. 2.

Attention is drawn to two International patent applications, namely International Patent Application No. PCT/GB99/03824 (published under No. WO01/36582) and International Patent Application No. PCT/GB99/01551 (published under No. WO 99/60092), the contents of which are incorporated herein by reference. Any individual feature or any combination of such features of any beverage disclosed in either of those International applications, and any method or apparatus or part of any method or apparatus disclosed in either of those International Applications may be utilised in the dispense of beverage which is the subject of this current application.

We claim:

1. A method of serving a drink to a person at a serving location, the method comprising: capturing an image at the serving location, providing an article, reproducing the image on the article, dispensing the drink, and presenting the drink and the article to the person.

2. A method according to claim 1 wherein the article is presented to the person with the drink.

3. A method according to claim 1 wherein the article is vessel, and the article is presented to the person containing the drink.

4. A method according to claim 3 wherein the vessel is a glass.

5. A method according to claim 1 wherein the article is a mat.

6. A method according to claim 1 wherein the drink is presented in a vessel and the article is applied to the vessel.

7. A method according to claim 6 wherein the article is a label.

8. A method according to claim 1 wherein the image is of a scene at the serving location.

9. A method according to claim 8 wherein the serving location is a room and the image is captured within the room.

10. A method according to claim 1 comprising selecting a person at the serving location, wherein the image is an image of the selected person.

11. A method according to claim 10 wherein the selected person is the person to whom the drink is served.

12. A method according to claim 1 wherein the image is reproduced by printing.

13. A method according to claim 3 wherein the image is reproduced on the vessel while the drink is being dispensed into the vessel.

14. A method according to claim 6 wherein the article is applied to the vessel while the drink is being dispensed into the vessel.

15. A method according to claim 1 wherein the article is a stirrer.

16. A method according to claim 1 wherein the article is a serviette.

17. A method of selling a drink to a customer at a point of sale, the method comprising: capturing an image at the point of sale, providing an article, reproducing the image on the article, dispensing the drink, and presenting the drink and the article to the customer.

18. Apparatus for serving a drink to a person, the apparatus comprising a camera for capturing an image, a printer for reproducing the image, a support for supporting a vessel, and a dispensing nozzle for dispensing the drink into the vessel.

19. Apparatus according to claim 18 wherein the apparatus is arranged to reproduce the image on the vessel.

20. Apparatus according to claim 19 wherein the printer is arranged to reproduce the image directly onto the vessel.

21. Apparatus according to claim 19 wherein the printer is arranged to print the image on an article which is adapted to be applied to the vessel.

22. Apparatus according to claim 21 wherein the apparatus is arranged to apply the article to the vessel.

23. Apparatus according to claim 18 wherein the printer is arranged to reproduce the image on an article intended to be presented to the person.

24. Apparatus according to claim 23 wherein the printer is arranged to reproduce the image on an object to be presented to the person with the drink.

25. Apparatus according to claim 23 wherein the article is a mat.

26. Apparatus according to claim 23 wherein the article is a stirrer.

27. Apparatus according to claim 23 wherein the article is a serviette.

28. Apparatus for serving a drink to a person, the apparatus comprising image capturing means for capturing an image, image reproducing means for reproducing the image, a support for supporting a vessel, and a dispensing nozzle for dispensing the drink into the vessel.

29. A drinks bar whereat a drink is to be served to a person, said bar being provided with a camera arranged to capture an image in the vicinity of the bar, and reproducing means to reproduce the image on an article intended to be presented to said person.

30. A drinks bar as claimed in claim 29 being further provided with a drink dispenser arranged to supply draught beverage, in which the reproducing means is disposed adjacent to the dispenser.

31. A drinks bar as claimed in claims 29 in which the printing means is in an enclosure.

32. A drinks bar as claimed in claim 31 being further provided with a drink dispenser arranged to supply draught beverage, wherein the dispenser is provided in said enclosure.

33. A method of serving a drink to a person at a serving location, the method comprising: selecting an image, providing an article, reproducing the image on the article, dispensing the drink, and presenting the drink and the article to the person.

34. A method according to claim 33 wherein the image is selected from a database of images.

35. A method of serving a drink to a person at a serving location comprising capturing an image at the serving location, transmitting the image for display at a remote location, and presenting the drink to the person.

36. A method according to claim 35 wherein the image is transmitted to a display screen for display.

37. A method according to claim 36 wherein the image is displayed instantaneously on the screen.

38. A method according to claim 36 wherein the image is transmitted to a remote receiving device and stored for viewing on request.

39. A method according to claim 38 wherein the remote receiving device is a mobile phone.

40. A method of decorating a beverage mat comprising capturing an image at a location and reproducing the image on the mat.

41. A method according to claim 40 wherein the image is reproduced directly onto the mat.

42. A method according to claim 40 wherein the image is reproduced onto a label and the label is applied to the mat.

43. A method according to claim 40 wherein the location is a bar area where beverage is served.

44. A method according to claim 43 wherein the image is of at least one person in the bar area.

45. A method according to claim 44 wherein the person is a customer purchasing a drink.

46. Apparatus for serving a drink to a person at a serving location, the method comprising: control means for selecting an image, image reproduction means for reproducing the image on the article, and dispensing means for dispensing the drink.

47. Apparatus according to claim 46 further comprising storage means having a database of images stored therein for selection by the control means.

48. Apparatus according to claim 47 further comprising a camera wherein the control means is arranged to control the camera so as to select the image.

49. Apparatus according to claim 46 further comprising communication means for downloading the image from a remote source.

50. Apparatus for decorating a beverage mat comprising a camera arranged to capture an image of a location and image reproduction means arranged to reproduce the image on the beverage mat.
